(19) United States
(12) Patent Application Publication
(10) Pub. No.: US 2018/0161898 A1
(43) Pub. Date: Jun. 14, 2018

(54) ELECTROCHEMICAL MACHINING DEVICE

(71) Applicant: METAL INDUSTRIES RESEARCH & DEVELOPMENT CENTRE, KAOHSIUNG CITY (TW)

(72) Inventors: YOU-LUN CHEN, KAOHSIUNG CITY (TW); DA-YU LIN, KAOHSIUNG CITY (TW); HUNG-YI CHEN, KAOHSIUNG CITY (TW); KUN-CHIN LAN, KAOHSIUNG CITY (TW); ZHI-WEN FAN, KAOHSIUNG CITY (TW); CHEN-HUI CHANG, KAOHSIUNG CITY (TW); CHIN-WEI LIU, KAOHSIUNG CITY (TW); CHEN-WEI WU, KAOHSIUNG CITY (TW)

(21) Appl. No.: 15/375,681

(22) Filed: Dec. 12, 2016

(51) Int. Cl. B23H 3/04; B23H 7/12

(52) U.S. Cl. CPC B23H 3/04; B23H 2400/10; B23H 7/12

(57) ABSTRACT

The present invention relates to an electrochemical machining device, which comprises a machining electrode, a driving module, a spacer, and a conductive electrode. The machining electrode includes an electrochemical machining zone. The driving module drives the machining electrode. The spacer is adjacent to the machining electrode. The conductive electrode is adjacent to the spacer. The spacer spaces the conductive electrode and the machining electrode. When the electrochemical machining device performs electrochemical processes, the driving module drives the machining electrode and moves a machining surface of the machining electrode.

### FIELD OF THE INVENTION

The present invention relates generally to a machining device, and particularly to an electrochemical machining device.

### BACKGROUND OF THE INVENTION

Generally, the mechanical cutting process is adopted for machining thin workpieces. The process faces many machining difficulties, for example, workpiece clipping, bending, and cutting. Alternatively, the stamping or polishing method may be adopted for machining workpieces. Nonetheless, similarly, material spilling or deckle edges will occur on the edges of workpieces. Other additional processes are required for removing the spilled material or decide edges, leading to increased processes, extended working hours, and increased manufacturing costs.

### SUMMARY

An objective of the present invention is to provide an electrochemical machining device for performing electrochemical processes.

Another objective of the present invention is to provide an electrochemical machining device for spacing the conductive electrode and the machining electrode.

A further objective of the present invention is to provide an electrochemical machining device for machining thin workpieces.

The present invention provides an electrochemical machining device, which comprises a machining electrode, a driving module, a spacer, and a conductive electrode. The machining electrode includes an electrochemical machining zone. The driving module drives the machining electrode and moves a machining surface of the machining electrode. The spacer is adjacent to the machining electrode. The conductive electrode is adjacent to the spacer. The spacer spaces the conductive electrode and the machining electrode.

### BRIEF DESCRIPTION OF THE DRAWINGS

FIG. 1 shows a stereoscopic diagram of the electrochemical machining device according to an embodiment of the present invention;

FIG. 2 shows another stereoscopic diagram of the electrochemical machining device according to an embodiment of the present invention;

FIG. 3 shows a side view of the electrochemical machining device according to an embodiment of the present invention;

FIG. 4 shows a cross-sectional view of the electrochemical machining device according to an embodiment of the present invention;

FIG. 5 shows an enlarged view of the region A in FIG. 4;

FIG. 6 shows another cross-sectional view of the electrochemical machining device according to an embodiment of the present invention;

FIG. 7 shows still another cross-sectional view of the electrochemical machining device according to an embodiment of the present invention; and

FIG. 8 shows another stereoscopic diagram of the electrochemical machining device according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

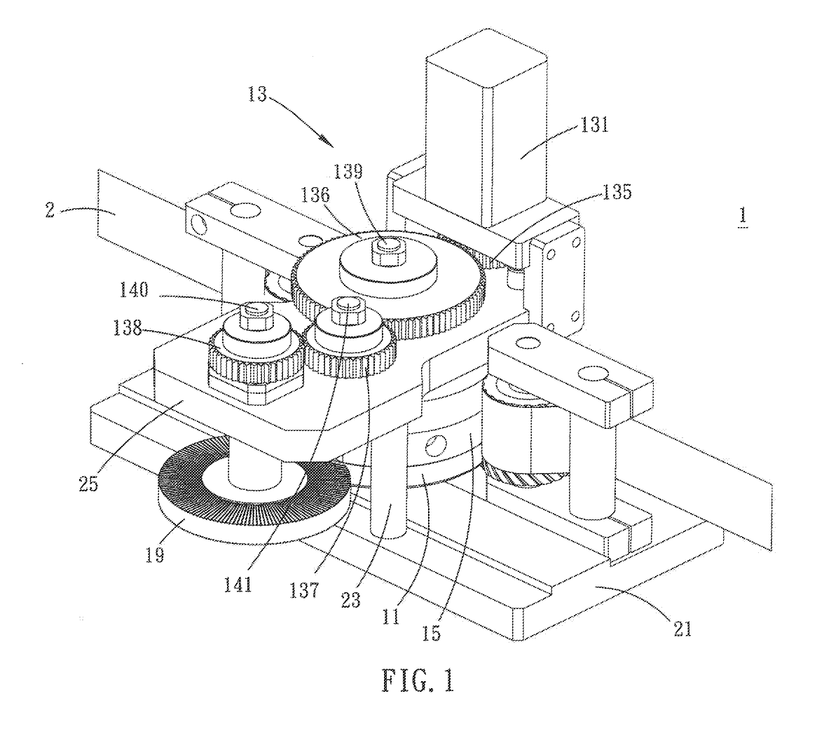

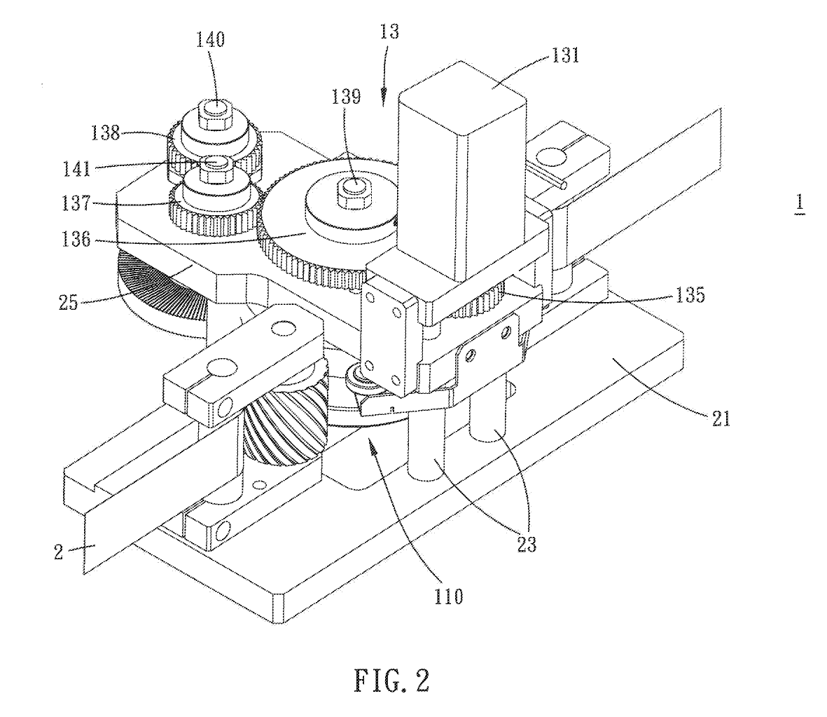

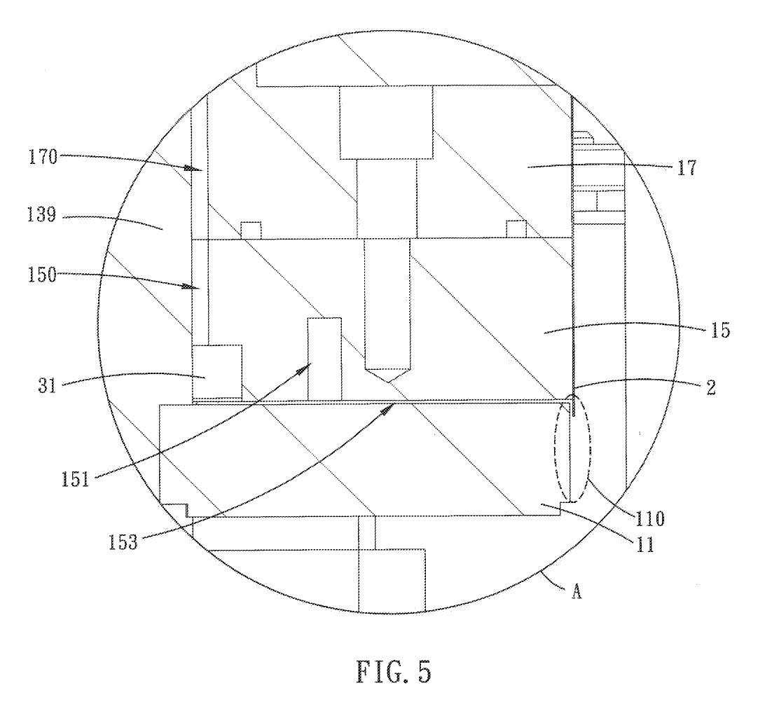

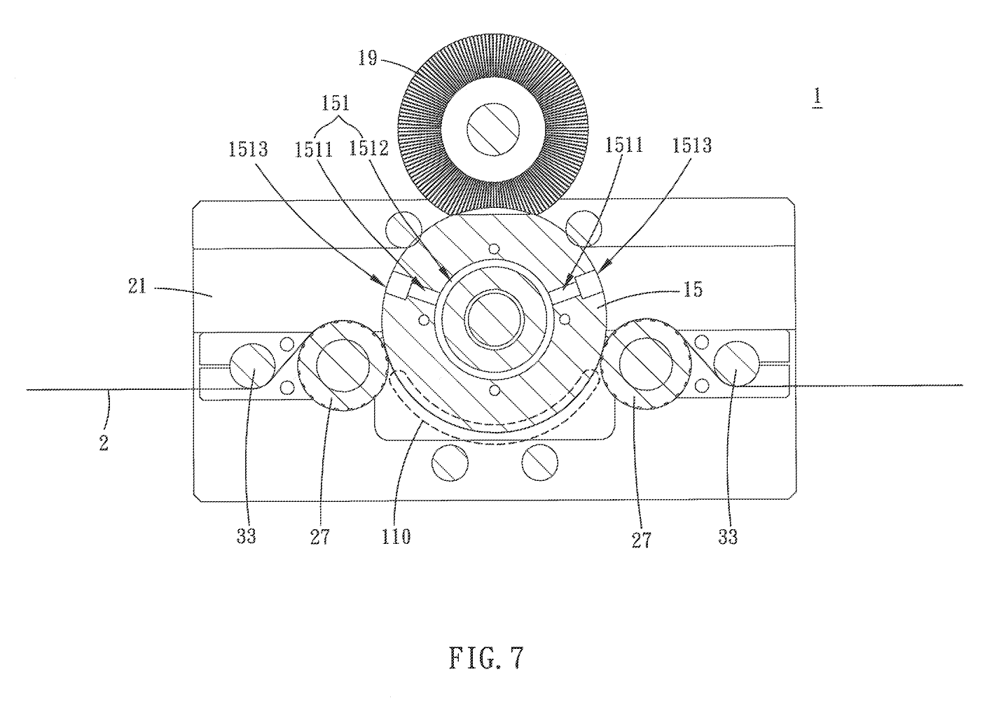

Please refer to FIGS. 1 and 2. The electrochemical machining device 1 according to the present invention comprises a machining electrode 11, a driving module 13, and a spacer 15. The machining electrode 11 is used for performing electrochemical processes on the workpiece 2. According to the present embodiment, thin (or strap) workpieces are adopted for performing continuous electrochemical processes. The machining electrode 11 includes an electrochemical machining zone 110, as shown in FIGS. 5 and 7, opposing to the machining surface of the workpiece 2 for performing electrochemical processes. According to an embodiment of the present invention, the electrochemical machining zone 110 is opposing to the lower edge of the workpiece 2 for machining to form knife edge. This is only an embodiment of the present invention. The electrochemical machining device 1 is not limited to the embodiment. The spacer 15 is adjacent to the machining electrode 11. When the electrochemical machining device 1 performs electrochemical processes, the driving module 13 drives the machining electrode 11 to move and thus moving the machining surface of the machining electrode 11 11 continuously.

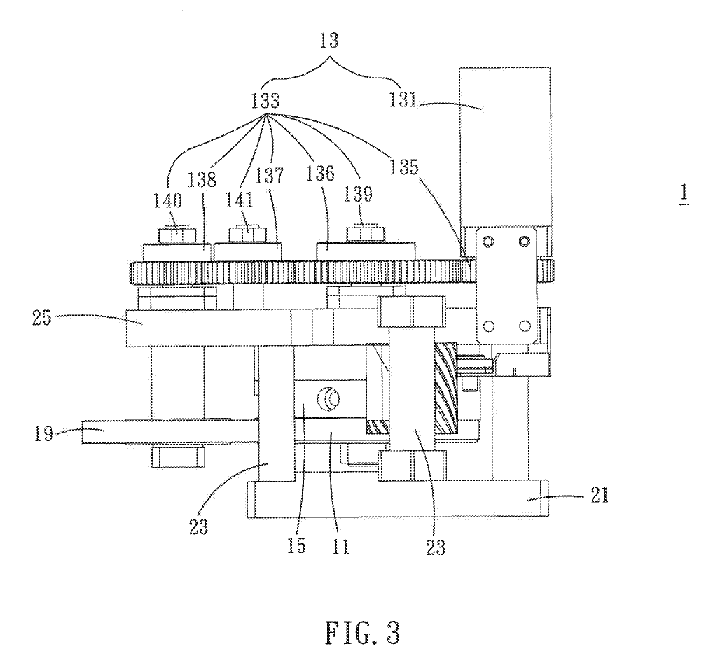

Please refer to FIGS. 3, 4, and 5. The electrochemical machining device 1 may further comprise a conductive electrode 17 adjacent to the spacer 15. The spacer 15 spaces the conductive electrode 17 and the machining electrode 11. According to the present embodiment, the spacer 15 may be an insulator. According to the present embodiment, the conductive electrode 17, the spacer 15, and the machining electrode 11 are all disc-shaped and arranged coaxially and perpendicularly. The conductive electrode 17 is coupled to the positive terminal of a power supply module (not shown in the figures) while the machining electrode 11 is coupled to the negative terminal. The conductive electrode 17 contacts the workpiece 2 for conducting positive power source to the workpiece 2. Because the spacer 15 is located between the conductive electrode 17 and the machining electrode 11, the spacer 15 may space the conductive electrode 17 and the machining electrode 11, and thus avoiding the conductive electrode 17 from contacting the machining electrode 11. Thereby, the spacer 15 may act as the barrier between the non-electrochemical machining zone and the electrochemical machining zone. According to the present embodiment, the non-electrochemical machining zone corresponds to the upper surface (the non-machining surface) region of the workpiece 2. Accordingly, the influence of electrochemical machining on the non-machining surface of the workpiece 2 may be reduced.

Because the machining electrode 11 according to the present embodiment is disc-shaped, its curved side surface (periphery) is the machining surface and opposing to the lower edge of the workpiece 2. Thereby, as shown in FIG. 5 and FIG. 7, the electrochemical machining zone 110 is the corresponding region of the side surface (the machining surface) of the machining electrode 11. The conductive electrode 17 and the spacer 15 are, likewise, disc-shaped, making their side surfaces curved. The side surface of the spacer 15 is adjacent to the side surface of the conductive electrode 17 and the side surface of the machining electrode 11. According to an embodiment of the present invention, the outer diameters of the spacer 15 and the conductive electrode 17 are identical and greater than the outer diameter of the machining electrode 11. Thereby, there is a gap between the machining electrode 11 and the workpiece 2.

During the electrochemical process performed by the machining electrode 11, machining products or impurities might adhere to the machining electrode 11. Thereby, according to the present embodiment, the electrochemical machining device 1 further comprises a cleaning unit 19 corresponding to the side surface of the machining electrode 11. This side surface does not oppose to the workpiece 2 and belongs to the non-electrochemical machining zone. The cleaning unit 19 may be a wheel brush contacting the side surface of the machining electrode 11. Thereby, as the machining electrode 11 rotates, the cleaning unit 19 may clean the surface of the machining electrode 11. The driving module 13 may further include a driving unit 131 and a transmission module 133. The driving unit 131 is connected to the transmission module 133 for driving the transmission module 133. The transmission module 133 is connected to the machining electrode 11 and the cleaning unit 19 for driving the machining electrode 11 and the cleaning unit 19 to rotate. According to an embodiment of the present invention, the driving unit 131 may be a motor.

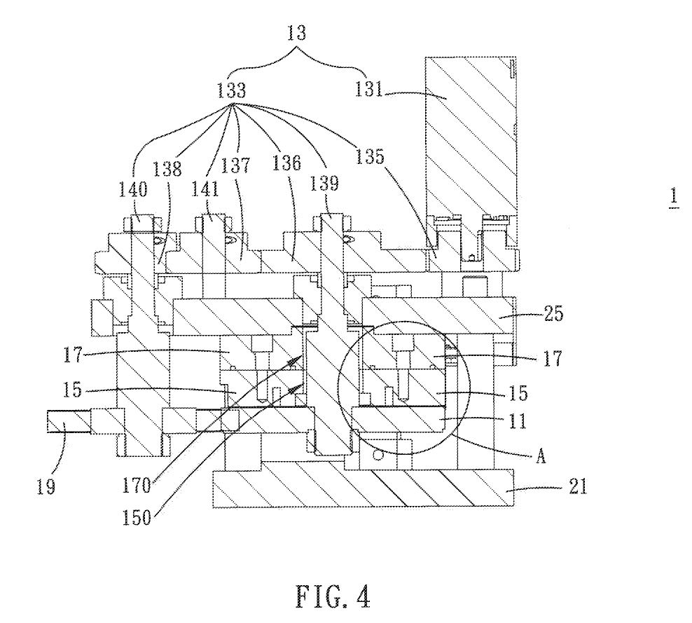

Please refer again to FIGS. 1 and 2. The electrochemical machining device 1 comprises a base 21, a plurality of supporting posts 23, and a platform 25. The plurality of supporting posts 23 are disposed on the base 21. The platform 25 is disposed on the plurality of supporting posts 23. As shown in FIGS. 3 and 4, the transmission module 133 further includes a first transmission gear 135, a second transmission gear 136, a third transmission gear 137, a fourth transmission gear 138, a first transmission shaft 139, a second transmission shaft 140, and an axis shaft 141. The driving unit 131 is disposed on the platform 25 and connected with the first transmission gear 135.

The transmission gears 135, 136, 137, 138 are all disposed on the platform 25. The first transmission gear 135 is connected with the driving unit 131 and geared to the second transmission gear 136. The first transmission shaft 139 passes through and relates to the second transmission gear 136. In addition, the first transmission shaft 139 passes through the platform 25, a first hole 170 of the conductive electrode 17, a second hole 150 of the spacer 15, and the machining electrode 11. The first transmission shaft 139 is connected with the machining electrode 11. When the driving unit 131 drives the first transmission gear 135, the latter drives the second transmission gear 136 to rotate, while the second transmission gear 136 drives the first transmission shaft 139 to spin for rotating the machining electrode 11. However, the conductive electrode 17 and the spacer 15 do not rotate with the first transmission shaft 139. As shown in FIG. 5, the conductive electrode 17 and the spacer 15 are fixed together, and there is a gap between the machining electrode 11 and the spacer 15.

The second transmission gear 136 is geared to the third transmission gear 137. The axis shaft 141 passes through and is connected with the third transmission gear 137. The axis shaft 141 is further fixed to the platform 25. The third transmission gear 137 is geared to the fourth transmission gear 138. The second transmission shaft 140 passes through and is connected with the fourth transmission gear 138. The second transmission shaft 140 further passes through the platform 25 and is connected to the cleaning unit 19. As the second transmission gear 136 rotates, it drives the third transmission gear 137, and the latter drives the fourth transmission gear 138. The fourth transmission gear 138 drives the second transmission shaft 140 to spin and thus rotating the cleaning unit 19. The rotating directions of the cleaning unit 19 and the machining electrode 11 are the same, making their contact surfaces to move in opposite directions. Thereby, as the cleaning unit 19 rotates, it will clean the surface of the machining electrode 11.

Please refer to FIGS. 5, 6, and 7. According to the present embodiment, the spacer 15 includes a first channel 151, which includes a straight channel 1511 and an annular channel 1512. One end of the straight channel 1511 is an inlet 1513 located on the side surface of the spacer 15. The other end of the straight channel 1511 communicates with the annular channel 1512. An outlet 1514 of the annular channel 1512 correspond to the machining electrode 11. Namely, the inlet 1513 of the first channel 151 is located on the side surface of the spacer 15. The outlet 1514 of the first channel 151 is annular and corresponds to the machining electrode 11. As shown in FIG. 5, there is a gap between the machining electrode 11 and the spacer 15 and forming a second channel 153. The second channel 153 communicates with the outlet 1514 of the first channel 151 and the side surface of the machining electrode 11. Thereby, the second channel 153 communicates with the electrochemical machining zone 119 and the contact area between the cleaning unit 19 and the machining electrode 11 for supplying electrolyte to the electrochemical machining zone 119 and the contact area between the cleaning unit 19 and the machining electrode 11.

Because the first channel 151 is located in the spacer 15 and the second channel 153 is located between the spacer 15 and the machining electrode 11, the spacer 15 may reduce electrolyte spills on the non-machining surface (the upper half surface) of the workpiece 2. In addition, because the workpiece 2 adheres to the curved surfaces of the conductive electrode 17 and the spacer 15, the workpiece 2 will become curved, which improves the anti-impact strength of the workpiece 2. As shown in FIG. 5, as the electrolyte flows from the second channel 153 and impacts the workpiece 2, thanks to the curved shape of the workpiece 2, the strength of resisting the impact of the electrolyte is increased. Thereby, the shakes on the lower half surface of the workpiece 2 caused by the impact from the electrolyte may be reduced, and hence the quality of electrochemical machining is improved. Furthermore, because there is no object on the rear surface (non-machining surface) of the workpiece 2 corresponding to the spacer 15 to lean on, there will be no capillarity. Accordingly, adhesion of electrolyte onto the rear surface of the workpiece 2 may be prevented, and thus avoiding the rear surface from being processed.

Please refer again to FIG. 5. sealing member 31 is disposed on the first transmission shaft 139 and located inside the spacer 15. The sealing member 31 corresponds to the machining electrode 11 and is dispose in the second hole 150 of the spacer 15. The sealing member 31 may block the electrolyte from flowing into the first hole of the spacer 15 and the second hole 170 of the conductive electrode 17 via the second channel 153.

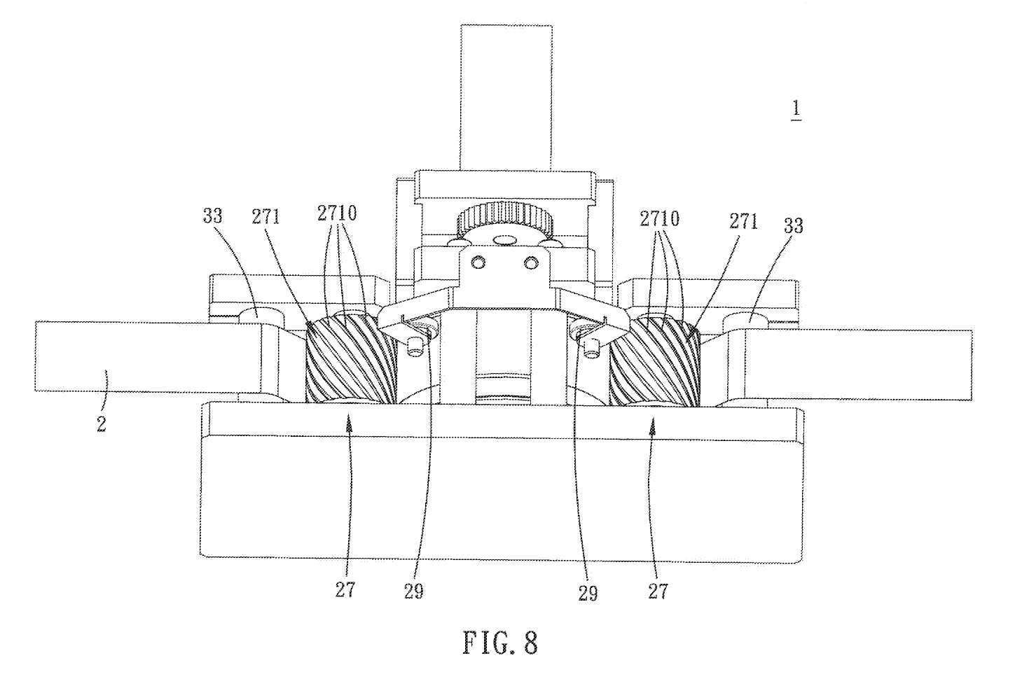

Please refer to FIG. 8. The electrochemical machining device 1 further comprises a workpiece guiding module 27 disposed on one side of the machining electrode 11. The workpiece guiding module 27 includes a plurality of guiding wheels 271 with each guiding wheel 271 having a plurality of oblique threads 2710. The direction of the plurality of oblique threads 2710 corresponds to the moving direction of the workpiece 2. According to an embodiment of the present invention, the direction of the oblique threads is from bottom right to top left, while the moving path of the workpiece 2 is from right to left. According to an embodiment of the present invention, the plurality of guiding wheels 271 are disposed before and after the machining electrode 11. Namely, they are located on the moving path of the workpiece 2. One side of the workpiece 2 is against the guiding wheels 271. When the electrochemical machining device 1 performs electrochemical processes, the guiding wheels 271 of the workpiece guiding module 27 will rotate and thus guiding the workpiece 2 to move. As the guiding wheels 271 rotate in one direction, the oblique threads 2710 of the guiding wheels 271 will enable the friction acting on the workpiece 2 to include an upward force component. That is to say, the oblique threads 2710 produce upward force and hence guiding the workpiece 2 to move upward in the moving process and providing the supporting force opposite to the gravity of the workpiece 2. In addition, the top edge of the workpiece 2 will be against the bottom surface of the platform 25. Thereby, the relative positions of the machining electrode 11 and the workpiece 2 may be aligned.

The electrochemical machining device 1 further comprises one or more workpiece alignment member 33 disposed before or/and after the workpiece guiding module 27. One side surface of the workpiece 2 is against the workpiece alignment member 33. As the workpiece 2 moves, one side surface of the workpiece 2 is against the workpiece alignment member 33 while the other side surface is against the workpiece guiding module 27 and hence making the workpiece 2 S-shaped, as shown in FIG. 7.

The electrochemical machining device 1 further comprises one or more pressing member 29 opposing to the conductive electrode 17 and disposed on the platform 25. The pressing member 29 may be used to press one side surface of the workpiece 2 and thus enabling the other side surface of the workpiece 2 to be against the machining electrode 11 and the spacer 15 firmly. According to an embodiment of the present invention, the pressing member 29 may be a wheel member which may rotate as the workpiece 2 moves.

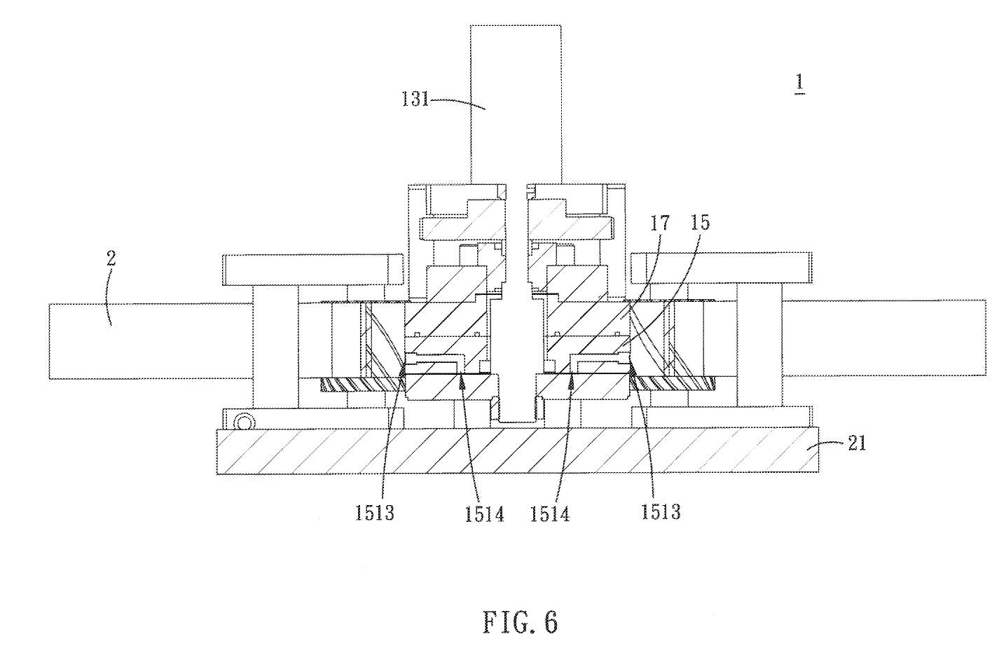

Please refer to FIGS. 1, 4, and 5. When the electrochemical machining device 1 performs electrochemical processes, one side of the workpiece 2 is against the spacer 15 and the conductive electrode 17. The conductive electrode 17 is connected to the positive power source while the machining electrode 11 is connected to the negative power source. The surface of the workpiece 2 contacts the conductive electrode 17 and is coupled to the positive power source. The electrolyte flows into the inlet 1513 of the first channel 151 of the spacer 15 (refer again to FIGS. 6 and 7), and then flows out to the second channel 153 from the outlet 1514 of the first channel 151. The electrolyte flows along the second channel 153 to the electrochemical machining zone 110. Namely, the electrolyte is supplied between the machining electrode 11 and the workpiece 2 for performing electrochemical processes on the workpiece 2.

At this moment, because the spacer 15 is located between the conductive electrode 17 and the machining electrode 11, the spacer 15 may prevent the conductive electrode 17 from contacting the machining electrode 11 and hence preventing short circuitry. In addition, the spacer 15 may reduce electrolyte spill on the non-machining surface of the workpiece 2. Moreover, performing electrochemical processes for a period of time, machining products or impurities might adhere to the surface of the machining electrode 11. The driving unit 131 drives the transmission module 133 and thus driving the first transmission gear 135 and the machining electrode 11 to rotate. Consequently, the machining surface of the machining electrode 11 is driven to move not opposing to the workpiece 2 while the unprocessed segment of the machining electrode 11 (the cleaned surface) is moved opposing to the electrochemical machining zone 110. Besides, the fourth transmission gear 138 drives the cleaning unit to rotate. The cleaning unit 19 contacts the surface of the machining electrode 11 for removing the machining products or impurities adhered to the surface of the machining electrode 11 mechanically and hence cleaning the surface of the machining electrode 11.

Please refer again to FIG. 8. During electrochemical processes, a traction device (not shown in the figure) tractions the workpiece 2 to move. As a partial segment of the workpiece 2 has finished electrochemical machining, the traction device tractions the workpiece 2 to move forward. Thereby, the unprocessed segment of the workpiece 2 is moved opposing to the machining electrode 11 and the electrochemical process is continued. During the process when the workpiece. 2 is moved, the side surface of the workpiece 2 is against the guiding wheel 271, which guides the workpiece 2 to move. In addition, the pressing member presses the workpiece 2 to the conductive electrode 17 so that the workpiece 2 may adhere closely to the conductive electrode 17 and the spacer 15. Thereby, excellent electrical conductivity may be established between the workpiece 2 and the conductive electrode 17.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An electrochemical machining device, comprising:
a machining electrode, having an electrochemical machining zone;
a driving module, driving said machining electrode, and moving a machining surface of said machining electrode;
an insulating spacer, adjacent to said machining electrode; and
a conductive electrode, adjacent to said insulating spacer;
wherein said insulating spacer spaces said conductive electrode and said machining electrode; and said machining electrode, said insulating spacer and said conductive electrode are arranged coaxially and perpendicularly.

2. (canceled)

3. The electrochemical machining device of claim 1, wherein said electrochemical machining zone is a corresponding region of a curved side surface of said machining electrode; a side surface of said conductive electrode is curved; a side surface of said insulating spacer is curved; and said side surface of said insulating spacer is adjacent to said side surface of said conductive electrode.

4. The electrochemical machining device of claim 1, further comprising a pressing member opposing said conductive electrode.

5. The electrochemical machining device of claim 1, wherein said machining electrode, said insulating spacer, and said conductive electrode are disc-shaped; said driving module drives said machining electrode to rotate for moving said machining surface of said machining electrode.

6. The electrochemical machining device of claim 5, wherein said driving module further includes a driving unit and a transmission module; said driving unit is connected with said transmission module; and said transmission module is connected with said machining electrode.

7. The electrochemical machining device of claim 6, wherein said conductive electrode and said insulating spacer include a hole, respectively; said transmission module includes a first transmission gear, a second transmission gear, and a transmission shaft; said first transmission gear is connected with said driving unit and geared with said second transmission gear; said transmission shaft passes through said second transmission gear, said hole of said conductive electrode, and said hole of said insulating spacer, and is connected with said machining electrode; and said transmission shaft is connected with said second transmission gear.

8. The electrochemical machining device of claim 1, further comprising a cleaning unit corresponding to said machining electrode.

9. The electrochemical machining device of claim 8, wherein said driving module further includes a driving unit and a transmission module; said driving unit is connected with said transmission module; and said transmission module is connected with said machining electrode and said cleaning unit.

10. The electrochemical machining device of claim 9, wherein said machining electrode, said insulating spacer, and said conductive electrode are disc-shaped; said conductive electrode and said insulating spacer include a hole, respectively; said transmission module includes a plurality of transmission gears, a first transmission shaft, and a second transmission shaft; said plurality of transmission gears are geared to one another; one of said plurality of transmission gears is connected with said driving unit; said first transmission shaft passes through one of said plurality of transmission gears, said hole of said conductive electrode, and said hole of said insulating spacer, and is connected with said machining electrode; and said first transmission shaft is connected with said transmission gear through which said transmission shaft passes; and said second transmission shaft passes through another transmission gear of said plurality of transmission gears and is connected with said cleaning unit.

11. The electrochemical machining device of claim 8, wherein said cleaning unit is a wheel brush.

12. The electrochemical machining device of claim 1, further comprising a workpiece guiding module, disposed on one side of said machining electrode, including a plurality of guiding wheels, each said guiding wheel having a plurality of oblique threads, and said plurality of oblique threads producing an upward force, respectively, as said plurality of guiding wheels rotates in one direction.

13. The electrochemical machining device of claim 1, wherein said insulating spacer includes a first channel with an inlet located on the side surface of said insulating spacer and an outlet corresponding to said machining electrode.

14. The electrochemical machining device of claim 13, wherein said outlet of said first channel is annular.

15. The electrochemical machining device of claim 14, further comprising a second channel located between said insulating spacer and said machining electrode and communicating with said outlet of said first channel and said electrochemical machining zone.
